(19) United States
(12) Patent Application Publication
(10) Pub. No.: US 2003/0034312 A1
(43) Pub. Date: Feb. 20, 2003

(54) Method and apparatus for treatment of biological material

(76) Inventors: Peter Unger, Stockholm (SE); Eric Westberg, Lidingo (SE)

Correspondence Address: GAMBRO, INC, PATENT DEPARTMENT, 10810 W COLLINS AVE, LAKEWOOD, CO, 80215, US

(21) Appl. No.: 10/065,073

(22) Filed: Sep. 13, 2002

Related U.S. Application Data
(63) Continuation of application No. PCT/SE01/00545, filed on Mar. 15, 2001.

(51) Int. Cl. C02F 1/00

(52) U.S. Cl. 210/772

(57) ABSTRACT

Method, container set, cassette and apparatus for the treatment of blood and blood products. A container set is arranged in a cassette that is inserted in a treatment apparatus. The process involves mixture with an agent, followed by irradiation and incubation, whereby the liquid is moved between containers through application of program controlled pressure pads and valves.

### BACKGROUND OF INVENTION

This Application is a continuation of International Application PCT/SE01/00545 filed Sep. 15, 2001 and which claims priority from Swedish Application 0000866-4 filed Mar. 16, 2000.

The present invention relates to a method and an apparatus for treatment of biological materials, such as blood components. More specifically, the invention relates to treatment of blood components in which the blood component is transferred from one container to another for performing said treatment, which may be irradiation of the blood component for activation of a virus inactivation agent, or filtering of the blood component.

Systems for treatment of blood, such as separation of whole blood in blood components are previously known from e.g. U.S. Pat. No. 5,279,797, U.S. Pat. No. 5,135,646 and U.S. Pat. No. 4,976,851. These patents discloses processes for separating whole blood into its components. The whole blood is placed in a container and exposed to centrifugation for separation in plasma, platelets and erythrocytes. The container is connected to a container set and the set is arranged in a machine for exerting a mechanical pressure to the container for pressing out the separated blood components from the first container, first the plasma into a second container, then the platelets into a third container in order to maintain the erythrocytes in the first container. Then the blood components are stored, which may involve freezing.

U.S. Pat. No. 5,723,050 discloses a centrifugation method and apparatus for carrying out separation of a blood component, in this case a thrombocyte suspension, and simultaneously performing the transportation of the separated blood component into a separate container.

When the blood component has been separated, it is normally stored for a specific time period until it can be used for transfusion. The blood component must be preserved during this time period. After the storage and before transfusion, the blood component is often exposed to virus inactivation, in order to reduce or even eliminate the risk of virus infection. Such virus inactivation involves adding to the blood component a virus inactivation agent or liquid. Such addition of virus inactivation agent may take place before the storage or shortly before transfusion. Such inactivation agents normally requires activation by irradiation of ultraviolet light to perform its virus inactivation ability. Moreover, there may be required some incubation time at a certain temperature.

Modern blood banks have a need for cost effective procedures and machines when preparing blood components in a safe and effective manner. One application where the proposed processing technique would be effective is in the inactivation of virus and/or pathogens in cellular blood products such as red cell and platelet preparations. Currently, virus and pathogen inactivation entails adding photo-activated materials and exposure of the suspension to light of a suitable wave length, often ultra violet light for a given time interval. These procedures are carried out using machines that are costly and require extensive manual work input. Future probable frequent use of these inactivation procedures point to the need of procedures which permit the automation of the procedures using technology which is simple, flexible and inexpensive.

### SUMMARY OF INVENTION

The object of the present invention is to provide a method, a container set, a cassette and an apparatus for the treatment of blood components before transfusion.

In the following is described a procedure and apparatus for inactivation of virus and pathogens.

The major principle of the invention is to connect the flexible container or plastic bag comprising the blood component to be treated with a container set, comprising two or more containers. The container set is placed in a special cassette with suitably placed displacement pads for moving the contents of the different bags in the bag set from one container to another. The cassette is placed in a treatment apparatus for exposing the blood component in a container of the container set for irradiation using a UV light source.

By using a cassette, the safety of the system will be high, since mistakes are not possible as each identified biological product is encapsulated in a cassette. Not until the treatment process has been completed can the blood component be removed from the cassette and be ready for transfusion.

Further objects, features and advantages of the invention will become apparent from the following detailed description of the invention with reference to the accompanying drawings which show several embodiments of the invention.

### BRIEF DESCRIPTION OF DRAWINGS

FIG. 1 is a schematic plan view of a container set according to the invention.

FIG. 2 is a horizontal view of a cassette without a container set.

FIG. 3 is an end view of the cassette according to FIG. 2.

FIG. 4 is a view from above of the stationary part before the cassette has been inserted.

FIG. 5 is a cross-sectional view taken according to line V-V in FIG. 4.

FIG. 6 is a schematic plan view similar to FIG. 1 of an alternative container set according to the invention.

### DETAILED DESCRIPTION

The invention is described below with reference to an example where a reactive agent or liquid is added to a blood product and the suspension is both irradiated and incubated.

At the beginning of the procedure, the blood product is found in a container 1. The container 1 is provided with an entrance tube 6 for entering the blood component, which is severed when the blood product has been provided. Moreover, the container comprises a sterile connector 7 for connection to the container set according to the invention.

Thus, container 1 is connected through the sterile coupling 7 and a tube 2a of predetermined length with a container 2 which comprises a reactive agent or substance. Container 2 is in turn connected to a processing container 3 through connector 8, which may also be a sterile connector, again using tubes 3a of predetermined length.

In order to avoid that the reactive liquid is transferred too soon to the container 3, the connecting tube 3a is closed using a tube clamp 11. Furthermore, the processing container 3 is connected to an incubation container 4 by means of a tube 4a. Finally, the incubation container 4 is connected to an infusion container 5 by a tube 5a which is substantially longer than tubes 3a and 4a. Moreover, the container 5 is provided with a transfusion connector 10 for connection to a transfusion set as is conventional practice.

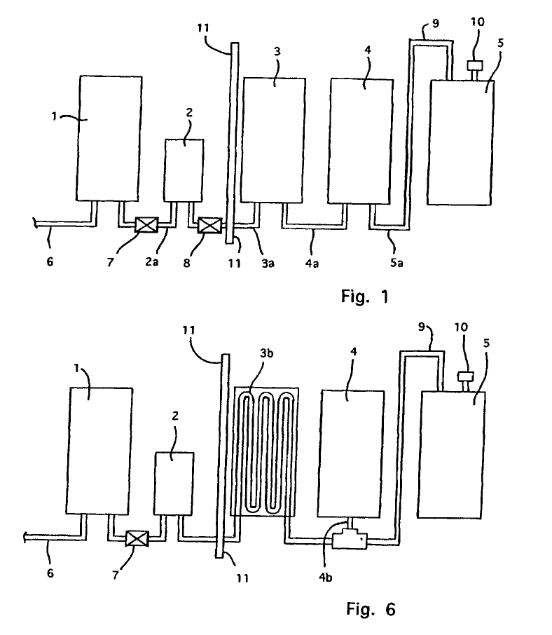

The container set is arranged as shown in FIG. 1 in order to facilitate the transportation of the liquids between the different containers so the entire contents of the respective container is passed over to the next container. This is accomplished since the tubes are connected to the containers in the bottom portion thereof. However, the last container 5 is arranged in the opposite direction. If air is transported with the liquids to container 5, such air will accumulate at the top of container 5 and can easily be removed back into tube 5a and previous containers by exerting a gentle pressure on container 5. In this way, a infusion product may be obtained which is free of air and is ready for infusion.

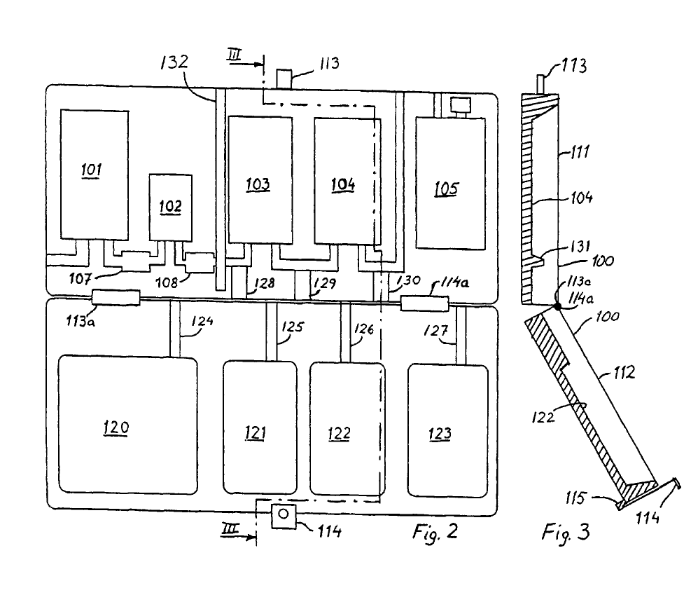

The container set described so far, is intended to be placed in a cassette 100 according to FIG. 2 for processing. Thus, the cassette is provided with recesses corresponding to the containers and tubes as described with reference to FIG. 1. These recesses are labeled with 101, 102, 103, 104, 105, 107 and 108. As appears to the left in FIG. 2, a portion of tube 5a, viz. portion 9 will be arranged outside of cassette 100. Thus, tube portion 9 is accessible from outside of cassette 100 for severing the tube before opening of the cassette. The tube portion 9 may also be inspected so that it is determined that no air is introduced into container 5 as described in more details below. Furthermore, the cassette is provided with a recess 132 for accomodating the clamp 11.

Cassette 100 is composed of two halves 111 and 112 which are interconnected by hinges 113a and 114a as also shown in FIG. 3. Moreover, each cassette halve is provided with a locking mechanism 113 and 114. Cassette halve 111 is arranged for receiving the container set according to FIG. 1.

The other cassette halve 112 is provided with several pressure pads 120, 121, 122 and 123, by means of which liquids are moved between the different containers and by means of which the different liquids in the different containers may be mixed as further described below. Each pressure pad 120-123 is connected to the bottom side of the cassette via tubes 124, 125, 126 and 127.

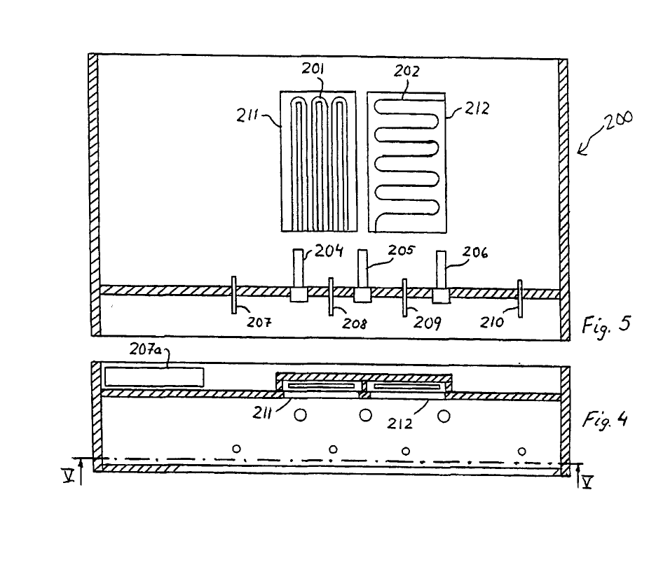

The apparatus, according to the invention comprises a stationary part 200 as shown in FIGS. 4 and 5, to carry out the predetermined process. The apparatus 200 comprises an ultraviolet irradiation lamp 201 and an incubation heater element 202. Moreover, the apparatus 200 comprises three solenoid-activated clamping devices 204, 205 and 206 arranged as shown. Finally, the apparatus comprises four pneumatic connectors 207, 208, 209 and 210 each connected to a source of pneumatic power (not shown).

Below, a procedure for virus inactivation of a erythrocyte suspension will be described in detail. The erythrocyte suspension is present in container 1 and a virus inactivation agent is present in container 2. First, container 2 is connected to the container set 3-10 via sterile connector 8, which may be a sterile connector of the type disclosed in co-pending Swedish Patent Application No. 0001278-1 filed Apr. 6, 2000. The contents of this Swedish Patent Application is incorporated in the present specification by reference. Clamp 11 is placed as shown to prevent the agent from flowing into container 3.

Then, the erythrocyte suspension container 1 is connected to container 2 by means of sterile connector 7, and the container set is inserted in the cassette which is closed. Then, the cassette is inserted in the apparatus 200 with the container set inserted in the cassette and the following procedure is performed. The pneumatic connectors 207-210 are connected to tubes 124-127 and thus to respective pressure pads 120-123. Each pressure pad is arranged opposite each container 1, 3, 4 and 5. There is no separate pressure pad for container 2. The clamps 204-206 pass into recesses 128, 129 and 130 of the cassette for engagement with respective tubes 3a, 4a and 5a.

First, clamp 204 is activated to take over the action of the manual clamp 11, which now is removed via recess 132 in the cassette. Each clamping device is provided with a plunger which is extended upwards in FIG. 5 to act upon the tube 3a. A shoulder 131 in cassette halve 111 acts as support for the clamping device, which thus clamps tube 3a. Thence, clamp 205 is activated to clamp tube 4a and clamp 204 is released. Thence, pneumatic pressure is transferred to pressure pad 120 via connector 207, which exerts a pressure at containers 1 and 2 pressing the contents thereof into container 3. If it is desired to further mix or agitate the contents of container 3, pressure is transferred to pressure pad 121 via connector 208 in order to pass the fluid back to containers 1 and 2, the pressure in pad 120 being relieved. Then, the fluid is again transferred to container 3 by exerting a pressure at pressure pad 120 while relieving the pressure in pressure pad 121. Moreover, the pressure in pressure pad 121 may be fluctuating at a certain amplitude and frequency in order to further mix the contents of container 3.

When all fluid in containers 1 and 2 has been transferred to container 3, clamping device 204 is again activated to isolate container 3. Then, the contents of container 3 is exposed to ultraviolet light by activation of UV panels 201. These panels may be flash lamps giving flashes at certain intervals as controlled by a control device 207a, which controls all the procedure. The panel exposes the container 3 in the cassette for UV light through a window in the apparatus 200. The window may be an free opening or an opening which is closed with a material which transmits UV light. Cassette 100 or at least the cassette halve 111 is made of a material which is transparent to UV light. The exposure may take place during a time interval which may be a few seconds up to several minutes.

Upon exposure, the virus inactivation agent is activated and performs its action. It may take several minutes and requires that the process is performed at a certain temperature. This incubation is performed in a separate incubation container 4. Thus, the fluid is transferred to container 4 by closing clamp 206 and opening clamp 205. Moreover, a pressure is exerted at pressure pad 121 via tube connector 208 to press the fluid over to container 4. When all fluid has been transferred, the incubation is started. Then, power is connected to heat incubation panel 202 to heat the fluid in container 4. The panel is exposed to the cassette via a window, which may be opened or closed. Also, cassette halve 111 is made of a heat transmitting material. When the incubation time has passed, the virus inactivation is completed. The inactivation time may be anything from one minute to several hours, preferably about 30 minutes.

After completion of the virus inactivation, the fluid is transferred to container 5. This is accomplished by closing clamp 209 and opening clamp 210. Then, a pressure is exerted on pressure pad 122 to transfer the fluid to container 5. The fluid transfer is possible to overview manually via tube portion 9. When the transfer is terminated, the tube portion 9 is inspected manually to see if there is any air in the system. If this is the case, a slight pressure is exerted at pressure pad 123 to press back the air from container 5 to container 4. When this has happened, tube portion 9 is severed and sealed and the container 5 is ready for transfusion.

It is mentioned that container 3 is made of a plastic material which passes UV light so that the contents may be exposed to UV light. This material may not be suitable for storing certain sensitive substances or cell suspensions for a long time, and thus, the contents is transferred to container 4 which is made of a material which is suitable for longtime storage. Moreover, during incubation in container 4, the inactivation agent may be absorbed at certain absorption material, such as certain plastic material present in container 4.

The inactivation agent is provided in a separate container 2 in order that the container 2 may be separately sterilized and handled before the process. The rest of the container set is empty and may be sterilized separately.

In certain processes, it is possible to have the active agent in container 2 permanently connected to the rest of the container set, which may then be sterilized as a package. In this case, container 2 and container 3 may be combined into a single container.

The container 2 comprises according to the invention the treatment agent. However, in certain cases the container 2 may be a filter, such as a filter for removing leukocytes or other type of filter.

In other cases, the final container 5 may be replaced by the first container 1. This is for example the case if the system according to the present invention is used for rejuvenation of erythrocytes. Then, after treatment, the entire contents of bag 4 is retransmitted to container 1, which already is marked as to its identity. In this way, the security of the system may be further enhanced.

As appears from FIG. 3, the cassette 100 comprises a head or end 115 designed to close the pathway used to insert the cassette into the stationary part 200 in order to prevent surrounding air from interfering with the incubation or irradiation process.

All processes are controlled from a computer or microprocessor 207a shown in FIG. 4. This microprocessor controls the pneumatic pressure source and valves in the lines connected to connectors 207-210, the solenoid-operated clamps 204-206, the time and energy provided by the UV lamps 201, the temperature provided by the heating panel 202, as well as giving feedback to the user about the process.

This processing unit 207a also gives impulses and frequencies to the pressure pads to produce any pulsation needed to agitate the liquid. This section includes compressed air tubes and electrical cables that makes it possible to add another processing unit.

Additional applications for the apparatus include hydraulic pressure elements, connectors and valves in the container set. These variations do not, however, affect the main elements of the invention.

FIG. 6 shows another embodiment of the container set according to the invention. In this case, the third container (3) is replaced by a continuous exposure device, in the nature of a long tube 3b. In this case, pressure pad 121 is moved and arrange to act upon container 2, which is integrally connected with the container set without a sterile coupling. During the operation, the fluids in containers 1 and 2 are thoroughly mixed. Then, the mixed contents is passed through the tube section 3b at a constant flow rate and the fluid flow is exposed to UV radiation. The constant fluid flow is obtained by flowing in a predetermined volume of air in the pressure pads per time unit. The irradiated fluid is collected in container 4 and incubated as in the previous process.

In another embodiment, the irradiation is replaced by filtration and container 3 is replaced by a suitable filter, such as a leukocyte filter.

In FIG. 6, the connection to container 4 takes place by a single tube 4b connected to a T-piece. This alternative arrangement can be used in any of the container tubes of any embodiment.

As is evident to a skilled person, the clamp 11 can be replaced by other means, such as frangible pins in the tube sections.

As an alternative, the pressure pads may be hydraulically operated and the connectors are hydraulic connectors.

Hereinabove, the invention has been described with references to preferred embodiments with reference to the drawings. However, different combinations and modifications which occur to a skilled person reading the present specification is intended to be encompassed by the invention, which is only limited by the appended patent claims.

1. A container set for handling blood or blood products to virally inactivate such blood or blood products comprising
a first container;
a second container;
a first tube between the first and second container;
a third container;
a second tube between the second and third containers; wherein
the second container is made of a material which passes ultraviolet light to virally inactivate any blood product contained therein.

2. The container set of claim 1 further comprising
a fourth container; and
a third tube connecting the fourth container to the first container.

3. The container set of claim 2 further comprising
a fifth container
a fourth tube connecting the fifth container to the third container.

4. The container set of claim 1 further comprising a sterile connector on the first tube.

5. The container set of claim 2 further comprising a sterile connector on the third tube.

6. The container set of claim 3 further comprising
a first end on at least one of said containers;
a second end on another of said containers wherein said second end of said another container is opposite said first end of said at least one of said containers;
first and second tube ends on said one of said tubes wherein one of said first and second tube ends of said one of said tubes is connected to the first end of the at least one container and the other of said first and second tube ends of the one of said tubes is connected to the second end of said another container.

7. A cassette adapted to receive a container set including at least one container containing blood or blood products comprising
a first cassette portion for receiving the container set;
a second cassette portion comprising at least one pressure pad adapted to be arranged opposite at least one container of the container set wherein pressure can be exerted through the pressure pad onto at least one container to move any blood products contained therein.

8. The cassette of claim 7 wherein the container set has a plurality of containers and the cassette further
comprises a plurality of pressure pads adapted to move fluids out of and into the plurality of containers.

9. The cassette of claim 8 wherein the plurality of pressure pads are adapted to be connected to a pneumatic pressure source to apply pressure to the pressure pads.

10. The cassette of claim 8 wherein the container set has at least a first tube connecting two containers and the cassette further comprising
a first recess adapted to receive a clamp device for acting upon the first tube.

11. The cassette of claim 8 wherein the container set has a plurality of tubes for connecting the plurality of containers and wherein the cassette further comprises
a plurality of recesses adapted to receive a plurality of clamps for acting on the plurality of tubes.

12. The cassette of claim 7 further comprising
a plurality of receptacles for receiving a plurality of containers.

13. The cassette of claim 7 further comprising a hinge for connecting the first cassette portion to the second cassette portion.

14. The cassette of claim 7 further comprising a enlarged end on one of the first or second cassette portions adapted to block air in a cassette receiving pathway when the cassette is placed in the cassette receiving pathway of a processing apparatus.

15. The cassette of claim 7 further comprising
a locking mechanism to lock the first cassette portion to the second cassette portion wherein said at least one pressure pad is opposite the at least one container.

16. The cassette of claim 7 wherein said first cassette portion comprises a portion made of material transparent to ultraviolet radiation.

17. The cassette of claim 7 wherein said cassette is made of material transparent to ultraviolet radiation.

18. An apparatus for processing blood or blood products in containers comprising
a cassette for receiving at least one container having a blood or blood product therein wherein said cassette comprises at least one pressure pad;
a cassette receiving pathway; and
pressure source for acting on the pressure pad in the cassette wherein the assertion of pressure on said pressure pad of the cassette causes the pressure pad to exert pressure on at least one container contained in the cassette.

19. The apparatus of claim 1 8 further comprising
a source of radiation for irradiating at least one portion of the cassette to irradiate at least one container contained therein.

20. The apparatus of claim 1 8 further comprising
a source of heat for heating at least one portion of the cassette to heat at least one container contained therein.

21. The apparatus of claim 18 wherein the cassette is adapted to receive a plurality of containers connected by tubes, the apparatus comprising
at least one clamp to act on at least one tube.
